(19) United States
(12) Patent Application Publication
(10) Pub. No.: US 2013/0043436 A1
(43) Pub. Date: Feb. 21, 2013

(54) FEW-LAYERED GRAPHENE MATERIALS AND FILMS THEREOF PREPARING

(71) Applicants: Yongsheng Chen, Tianjin (CN); Minyu Xie, Tianjin (CN)

(72) Inventors: Yongsheng Chen, Tianjin (CN); Minyu Xie, Tianjin (CN)

(73) Assignee: TIANJIN PULAN NANO TECHNOLOGY CO., LTD., Tianjin (CN)

(21) Appl. No.: 13/582,542

(22) PCT Filed: Dec. 6, 2010
(86) PCT No.: PCT/CN2010/079473

§ 371 Date: Sep. 4, 2012

(30) Foreign Application Priority Data
Dec. 6, 2009 (CN) 200910250369.7

(51) Int. Cl. H01B 1/04; C01B 31/02; B82Y 40/00

(52) U.S. Cl. 252/502; 423/448; 977/842

(57) ABSTRACT

Disclosed are a process for preparing a solution comprising few-layered graphene, a process for preparing a few-layered graphene solid, and a process for preparing a film thereof.

### FIELD

The present application is directed to a carbon material and a process for preparing the same. In particular, the present application is directed to a process for preparing a solution comprising few-layered graphene having different layers, a process for preparing a solid of few-layered graphene having different layers and a process for preparing a film of few-layered graphene.

### BACKGROUND

Carbon is present in various forms including conventional graphite, diamond and amorphous carbon as well as recently discovered carbon-60, carbon nanotube and graphene. Although these materials consist of carbon element, the structures and properties of the materials are quite different. Graphene is single-layered graphite consisting of single-layered graphite or few-layered graphite. Graphene material possesses many excellent properties, such as high conductivity and mechanical properties. Therefore, films obtained from the graphene material have extensive application prospects. However, up to now there is no good large-scale preparation process. Therefore, there is a need for a simple and feasible large-scale preparation process in both research and industry application.

### SUMMARY

In one aspect, the present application provides a process for preparing a solution comprising few-layered graphene, the process comprising controllably oxidizing graphene with an oxidant in the presence of an acid.

In another aspect, the present application provides a process for preparing a few-layered graphene solid, the process comprising removing solvent from the above solution comprising few-layered graphene.

In still another aspect, the present application provides a process for preparing a film of few-layered graphene, the process comprising coating with the above solution comprising few-layered graphene or a solution prepared by mixing the above solution comprising few-layered graphene and a solvent, and reducing the resultant film by heating or with an reductant under inert gas atmosphere, then removing function groups on the graphene to obtain a high conductive film material.

### DESCRIPTION OF DRAWINGS

FIG. 1 is a graph of X-ray diffraction (XRD) data of a few-layered graphene solid according to the present application.

FIG. 2 is an atomic force microscope (AFM) cartogram of the thickness and layer number of a few-layered graphene solid according to the present application.

FIG. 3 is a curve of conductivity obtained from a few-layered graphene according to the present application.

### DETAIL DESCRIPTION

In the following description, certain specific details are included to provide a thorough understanding of various disclosed embodiments. One skilled in the relevant art, however, will recognize that the embodiments may be practiced without one or more these specific details, or with other methods, components, materials, etc.

Unless the context required otherwise, throughout the specification and claims which follows, the term “comprise” and variation thereof, such as “comprises” and “comprising” are to be construed in an open, inclusive sense, which is as “include, but not limited to”.

Reference throughout this specification to “one embodiment”, or “an embodiment”, or “in another embodiment”, or “in some embodiments” means that a particular referent feature, structure or characteristic described in connection with the embodiment is included in at least one embodiment. Therefore, the appearance of the phrases “in one embodiment” or “in the embodiment” or “in another embodiment” or “in some embodiments” in various places throughout this specification are not necessarily all referring to the same embodiment. Moreover, the particular features, structures or characteristics may be combined in any suitable manner in one or more embodiments.

It should be noted that, as used in this specification and the appended claims, the singular forms “a”, “an” and “the” include plural referents unless the context clearly stated otherwise. Therefore, for example, reference to the reaction containing “an acid” is to comprise one acid, or two acid or more. It should be also noted that the use of “or” means “and/or” unless stated otherwise.

As used herein, the term “few-layered graphene (FG)” refers to a multilayered (generally 2 to 30 layers) graphite material, of which the molecular forming unit is a “single-layered graphene”. The term “single-layerrd graphene” refers to a two-dimensional planar molecule skeleton consisting of single-layered carbon atoms, in which a single layer has an area of about 10 nm² to 1,000 μm² and a thickness of about 0.34 nm to 2 nm.

Carbon atoms on the layer edges of the “few-layered graphene” and “single-layered graphene” may attach to different organic functional groups, such as hydroxyl, amino, carboxyl, epoxy groups and the like, according to different specific preparation processes and preparation conditions.

As used herein, the term “intercalate” and variation thereof, such as “intercalating” and “intercalation” refer to inserting a substance (i.e. a guest, such as, sulfuric acid, nitric acid, and the like, and inorganic oxides, such as TiO₂, ZnO, WO₃, SnO₂, and the like) into another substance having a layered structure (i.e. a host, such as, graphite, hydrotalcite, and the like).

In one aspect, the present application provides a process for preparing a solution comprising few-layered graphene, the process comprising controllably oxidizing a graphene with an oxidant in the presence of an acid.

In some embodiments, the process for preparing a solution comprising few-layered graphene comprises:

controllably oxidizing a graphene with an oxidant in the presence of an acid; and

removing impurities from the reaction mixture with water and/or hydrogen peroxide.

In some embodiments, the process for preparing a solution comprising few-layered graphene comprises controllably oxidizing and intercalating a graphene with an oxidant in the presence of an acid.

In some embodiments, the process for preparing a solution comprising few-layered graphene comprises:

controllably oxidizing and intercalating a grapheme with an oxidant in the presence of an acid; and

removing impurities from the reaction mixture with water and/or hydrogen peroxide.

The exemplary oxidants that can be used in the process for preparing a solution comprising few-layered graphene according to the present application include, but are not limited to, permanganate, hypochlorite, chlorate, perchlorate, chromate, dichromate, persulfate of an alkali metal; or peroxides, such as hydrogen peroxide, dibenzoyl peroxide (BPO). The preferable oxidant is permanganate or dichromate of an alkali metal. The more preferable oxidant is KMnO₄.

In some embodiments, the weight ratio of the starting material graphene to an oxidant is 1:1 to 1:5. In some embodiments, the weight ratio of the starting material graphene to an oxidant is 1:2 to 1:3.

The exemplary acids that can be used in the process for preparing the solution comprising few-layered graphene according to the present application include, but are not limited to, concentrated sulfuric acid, concentrated nitric acid, perchloric acid, acetic acid and acetic anhydride. The preferable acid is concentrated sulfuric acid, concentrated nitric acid and a mixture thereof.

In some embodiments, the acid is used in an amount of 15 mL to 90 mL with respect to one gram of the starting material graphene.

In some embodiments, the acid is concentrated sulfuric acid and the amount of the concentrated sulfuric acid is 15 mL to 90 mL with respect to one gram of the starting material graphene. In some embodiments, the acid is concentrated sulfuric acid and the amount of the concentrated sulfuric acid is 20 mL to 50 mL with respect to one gram of the raw material graphite.

In some embodiments, the acid is a mixture of concentrated sulfuric acid and concentrated nitric acid, in which the concentrated nitric acid may be prepared in situ by reacting a nitrate of an alkali metal with sulfuric acid. The preferable nitrate of an alkali metal is sodium nitrate or potassium nitrate.

In some embodiments, the acid is a mixture of concentrated sulfuric acid and concentrated nitric acid obtained by reacting sodium nitrate with concentrated sulfuric acid, in which the amount of the concentrated sulfuric acid is 15 mL to 90 mL with respect to one gram of the starting material graphene, and the weight ratio of the starting material graphene to sodium nitrate is 1:0.5 to 1:2. In some embodiments, the acid is a mixture of concentrated sulfuric acid and concentrated nitric acid obtained by reacting sodium nitrate with concentrated sulfuric acid, in which the amount of the concentrated sulfuric acid is 15 mL to 90 mL with respect to one gram of the starting material graphene, and the weight ratio of the starting material graphene to sodium nitrate is 1:0.7 to 1:1. In some embodiments, the acid is a mixture of concentrated sulfuric acid and concentrated nitric acid obtained by reacting sodium nitrate with concentrated sulfuric acid, in which the amount of the concentrated sulfuric acid is 20 mL to 50 mL with respect to one gram of the starting material graphene, and the weight ratio of the starting material graphene to sodium nitrate is 1:0.5 to 1:2. In some embodiments, the acid is a mixture of concentrated sulfuric acid and concentrated nitric acid obtained by reacting sodium nitrate with concentrated sulfuric acid, in which the amount of the concentrated sulfuric acid is 20 mL to 50 mL with respect to one gram of the starting material graphene, and the weight ratio of the starting material graphene to sodium nitrate is 1:0.7 to 1:1.

In some embodiments, the oxidation reaction is carried out at the temperature of 10° to 80° C. In some embodiments, the oxidation reaction is carried out at the temperature of 30° to 50° C.

In some embodiments, the oxidation reaction time is 0.1 to 10 days. In some embodiments, the oxidation reaction time is 2 to 6 days.

The few-layered graphene obtained by the process for preparing a solution comprising few-layered graphene according to the present application may comprise different numbers of graphene layers.

In the process for preparing a solution comprising few-layered graphene according to the present application, after the oxidation reaction is completed, water and hydrogen peroxide are added into the reaction system to remove impurities from the reaction mixture. The amounts of the added water and the amount and concentration of the added hydrogen peroxide are not particularly limited as long as impurities can be removed from the reaction system.

In another aspect, the present application provides a process for preparing a few-layered graphene solid, the process comprising removing solvent from the above solution comprising few-layered graphene.

The process for removing solvent from the above solution comprising few-layered graphene may be any conventional process, such as evaporation, evaporation under reduced pressure, and the like.

In another aspect, the present application provides a process for preparing a film of few-layered graphene, the process comprising coating the above solution comprising few-layered graphene or a solution obtained by mixing the above few-layered graphene solid and a solvent, and heating the resultant film under inert gas atmosphere.

The exemplary solvents that can be used in the preparation of a solution comprising few-layered graphene may be any volatile solvent and include but are not limited to: water; amides such as N,N-dimethylformamide (DMF), N,N-dimethylacetamide and the like; alcohols such as ethanol, methanol, isopropanol and the like; dimethylsulfoxide (DMSO); chloro-solvents such as chlorobenzene, dichlorobenzene, dichloromethane and the like; esters such as ethyl acetate, methyl acetate, dimethyl phthalate (DMP) and the like.

The process for preparing a film of few-layered graphene according to the present application may be any well-known coating process in the art and includes but is not limited to spin coating, spraying, dipping and the like.

The process for preparing a film of few-layered graphene according to the present application may optionally comprise adding an additive such as a dispersing agent, a thickening agent and the like into the above solution comprising few-layered graphene or a solution obtained by mixing the above few-layered graphene solid and a solvent, before coating.

The process for preparing a film of few-layered graphene according to the present application may optionally comprise reducing in a reductive stream after coating. The functional groups on the graphene layers are controllably removed and the defects are repaired to restore the intrinsic conductivity of the graphene to obtain a high conductive film. Similarly, a reductant including a gaseous reductant may be used in the reduction reaction to obtain a conductive film of graphene.

In some embodiments, the reductive stream is hydrazine hydrate stream, hydrogen or ammonia gas.

The present application is described in detail by the examples below. However, the examples are only intended to further illustrate the invention but cannot be construed to limit the scope of protection of the present application. Any non-substantial improvement and modification made by one skilled in the art according to the above contents described herein falls within the scope of protection of the present application.

### EXAMPLES

### Example 1

To a 1 L round bottom three-necked flask were added 5.0 g of graphene and 3.75 g of NaNO₃. 190 ml of concentrated sulfuric acid was then slowly poured into the flask with stirring. After mixing homogeneously, 11.25 g of KMnO₄ solid was slowly added into the solution. The reaction mixture was kept in an ice bath for 3 hours to cool to the room temperature. After stirring for 6 days, to the reaction mixture was slowly added 500 mL of distilled water. The reaction solution was reacted for 3 hours at a constant temperature of 95° to 98° C. After the reaction solution was cooled, 15 mL of hydrogen peroxide (30 wt % aqueous solution) was added. The reaction solution was stirred at the room temperature. The impurities were removed from the reaction solution with centrifuge to obtain the product of the solution comprising few-layered graphene. Water and solvent were removed to obtain the product of the few-layered graphene.

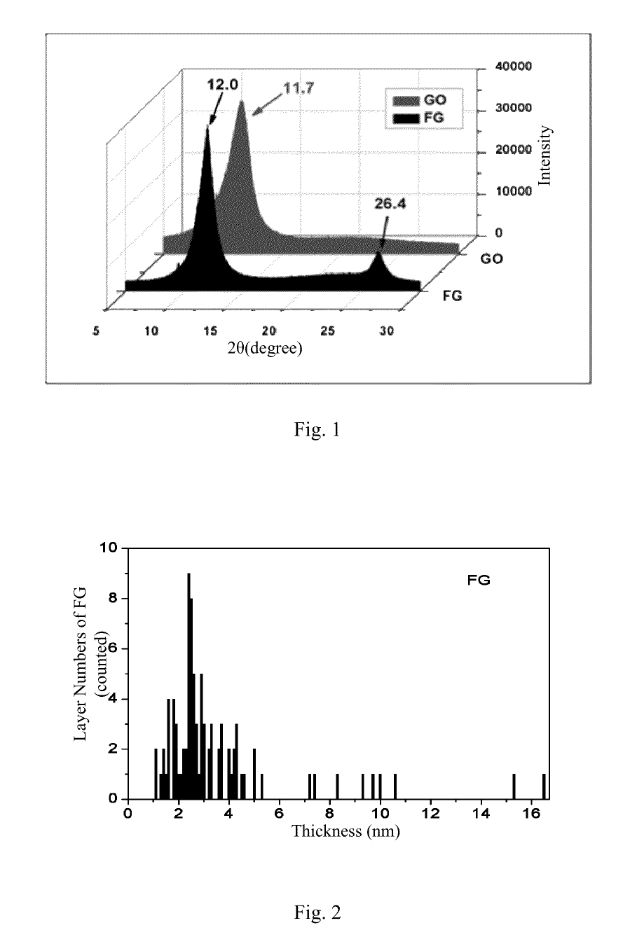

FIG. 1 shows the X-ray diffraction (XRD) data of the resultant few-layered graphene. As seen from FIG. 1, there is a diffraction peak of the few-layered graphene at the diffraction angle of 26.4°, comparing with the single-layered graphene, which indicates the resultant graphene product has a few-layered structure.

FIG. 2 is an atomic force microscope (AFM) cartogram of the thickness and layer numbers of the resultant few-layered graphene material. As seen from FIG. 2, the thickness of the few-layered graphene material is 0.5 to 10 nm and most of the thickness distributes between 2 and 4 nm. Such thickness range shows that the few-layered graphene consists of several to tens of layers of single-layered graphene.

### Example 2

To a 1 L round bottom three-necked flask were added 10.0 g of graphene and 8 g of NaNO₃. 400 ml of concentrated sulfuric acid was then slowly poured into the flask with stirring. After mixing homogeneously, 25 g of KMnO₄ solid was slowly added into the solution. The reaction mixture was kept in an ice bath for 3 hours to cool to the room temperature. After stirring for 8 days, to the reaction mixture was slowly added 1,000 mL of distilled water. The reaction solution was reacted for 5 hours at a constant temperature of 95° to 98° C. After the reaction solution was cooled, 30 mL of hydrogen peroxide (30 wt % aqueous solution) was added. The reaction solution was stirred at the room temperature. The impurities were removed from the reaction solution with centrifuge to obtain the product of the solution comprising few-layered graphene. Water and solvent were then removed to obtain the product of the few-layered graphene.

### Example 3

0.1 mg of the few-layered graphene obtained in Example 1 or 2 was ultrasonically mixed with 1 mL of DMF to obtain a solution of few-layered graphene in DMF.

### Example 4

6 mg of the few-layered graphene obtained in Example 1 or 2 was mixed homogeneously with 1 mL of water to obtain an aqueous solution of few-layered graphene.

### Example 5

The solution comprising few-layered graphene obtained in Example 1 or 2, or the solution of few-layered graphene obtained in Example 4 was spin coated on a clean glass. The resultant coating was dried and then reduced (under inert gas atmosphere and at 400° C.) for 2 hours to obtain a conductive film of few-layered graphene.

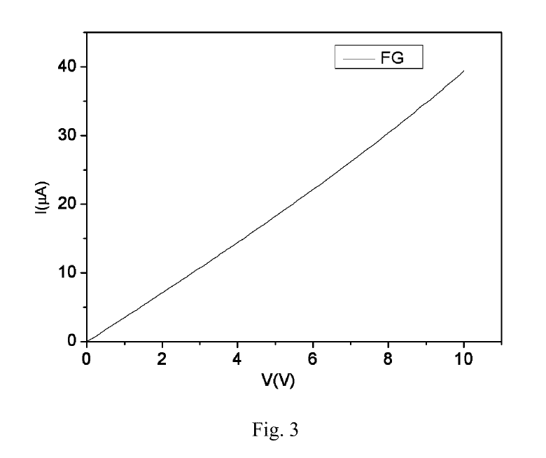

FIG. 3 is a curve of conductivity obtained from a few-layered graphene of the invention. The conductivity of the conductive film is about 100 S/cm, as calculated from FIG. 3, which is better than the conductivity of a film of single-layered graphene obtained under the same conditions.

### Example 6

The solution comprising few-layered graphene obtained in Example 1 or 2, or the solution of few-layered graphene obtained in Example 4 was spin coated on a clean glass. The resultant coating was reduced by a hydrazine hydrate stream, and then reduced by heating (under inert gas atmosphere and at 400° C.) for 2 hours to obtain a conductive film of few-layered graphene. The conductivity of the resultant film was 110 S/cm, which was better than the conductivity of a film of single-layered graphene obtained under the same conditions.

### Example 7

The solution comprising few-layered graphene obtained in Example 1 or 2, or the solution of few-layered graphene obtained in Example 4 was spin coated on a clean glass. The resultant coating was reduced by a hydrazine hydrate stream to obtain a conductive film of few-layered graphene. The conductivity of the resultant film was 0.03 S/cm.

1. A process for preparing a solution comprising few-layered graphene, the process comprising:
controllably oxidizing a graphene with an oxidant in the presence of an acid.

2. The process of claim 1, wherein the oxidant is selected from the group consisting of permanganate of an alkali metal, hypochlorite of an alkali metal, chlorate of an alkali metal, perchlorate of an alkali metal, chromate of an alkali metal, dichromate of an alkali metal, persulfate of an alkali metal, and peroxides.

3. The process of claim 1, wherein the weight ratio of the graphene to the oxidant is 1:1 to 1:5.

4. The process of claim 1, wherein the acid is selected from the group consisting of concentrated sulfuric acid, concentrated nitric acid, perchloric acid, acetic acid, acetic anhydride, and a mixture thereof.

5. The process of claim 1, wherein the acid is concentrated sulfuric acid, and the amount of the concentrated sulfuric acid is 15 mL to 90 mL, with respect to one gram of the starting material graphene.

6. The process of claim 1, wherein the acid is a mixture of concentrated sulfuric acid and concentrated nitric acid, and wherein the concentrated nitric acid may be prepared in situ by reacting sodium nitrate or potassium nitrate with sulfuric acid.

7. The process of claim 6, wherein the acid is a mixture of concentrated sulfuric acid and concentrated nitric acid prepared in situ by reacting sodium nitrate with concentrated sulfuric acid, and wherein the amount of the concentrated sulfuric acid is 15 mL to 90 mL, with respect to one gram of the starting material graphene, and the weight ratio of the starting material graphene to the sodium nitrate is 1:0.5 to 1:2.

8. The process of claim 1, wherein the oxidation reaction is carried out at the temperature of 10° to 80° C.

9. The process of claim 1, wherein the oxidation reaction time is 0.1 to 10 days.

10. The process of claim 1, further comprising removing impurities from the reaction mixture with water and/or hydrogen peroxide.

11. A process for preparing a few-layered graphene solid, the process comprising removing solvent from the solution comprising few-layered graphene prepared by the process of claim 1.

12. A process for preparing a film of few-layered graphene, the process comprising coating the solution comprising few-layered graphene prepared by the process of claim 1 and heating the resultant film under inert gas atmosphere.

13. The process of claim 17, wherein the solvent is selected from the group consisting of water; amides alcohols; chloro-solvents; and esters.

14. The process of claim 12, further comprising adding an additive into the solution comprising few-layered graphene before coating.

15. The process of claim 12, further comprising reducing in a reductive stream after coating.

16. The process of claim 15, wherein the reductive stream is selected from the group consisting of hydrazine hydrate stream, hydrogen and ammonia gas.

17. A process for preparing a film of few-layered graphene, the process comprising coating a solution prepared by mixing the few-layered graphene solid prepared by the process of claim 11 and a solvent, and heating the resultant film under inert gas atmosphere.

18. The process of claim 17, further comprising adding an additive into the solution before coating.

19. The process of claim 17, further comprising reducing in a reductive stream after coating.

20. The process of claim 17, wherein the reductive stream is selected from the group consisting of hydrazine hydrate stream, hydrogen and ammonia gas.
